(19) United States
(12) Patent Application Publication
(10) Pub. No.: US 2015/0264548 A1
(43) Pub. Date: Sep. 17, 2015

(54) ECALL SYSTEM AND METHOD

(71) Applicant: VIA TELECOM, INC., San Diego, CA (US)

(72) Inventor: ANTHONY S. LEE, San Diego, CA (US)

(21) Appl. No.: 14/642,551

(22) Filed: Mar. 9, 2015

Related U.S. Application Data
(60) Provisional application No. 61/951,091, filed on Mar. 11, 2014.
(60) Provisional application No. 61/968,053, filed on Mar. 20, 2014.

(51) Int. Cl. H04W 4/22

(52) U.S. Cl. CPC H04W 4/22

(57) ABSTRACT

An emergency call apparatus is provided that includes an applications processor and a code division multiple access (CDMA) modem. The applications processor is configured to receive current location data and vehicle crash data from sensors disposed in an automotive vehicle, and is configured to automatically establish a voice connection with an emergency services center, and is configured to transmit the location and vehicle crash data to the emergency services center within a prescribed time period. The CDMA modem is coupled to the applications processor and is configured to format and transmit a plurality of protocol data units (PDUs) over a single traffic channel that includes both primary traffic corresponding to the voice connection and other traffic corresponding to the location and vehicle crash data.

### CROSS-REFERENCE TO RELATED APPLICATIONS

This application claims the benefit of the following U.S. Provisional applications, each of which is herein incorporated by reference for all intents and purposes.

| | FILING | |
|---|---|---|
| SERIAL NUMBER | DATE | TITLE |
| 61/951,091 | Mar. 11, 2014 | ECALL SYSTEM |
| (VTU.14-0011-US) | | |
| 61/968,053 | Mar. 20, 2014 | ECALL SYSTEM |
| (VTU.14-0012-US) | | |

### BACKGROUND OF THE INVENTION

1. Field of the Invention

This invention relates in general to the field of wireless communications, and more particularly to an apparatus and method for implementing automatic emergency calls via a code division multiple access (CDMA) mechanism.

2. Description of the Related Art

The wireless communications industry is undergoing exponential growth, not only in this country, but all over the world. In fact, it is well known that the over twenty percent of the adult population in the United States do not even have a traditional landline telephone. In addition to those who do not own a conventional telephone, nearly ninety percent of the adult population owns a wireless phone.

And the usage of cell phones is increasing as well over the use of traditional landline telephone coverage. In fact, one in seven adults now uses only cell phones. Whereas in the past cell phones were used when a landline was not available or under emergency conditions, lower carrier rates, affordability of family packages, and free mobile-to-mobile or friend-to-friend promotions have fostered in significant increases in usage. It is not uncommon today to walk into any public forum or facility and notice a majority of the people there talking on their cell phones.

The ability to communicate using a mobile phone, or mobile station, has been available since the middle of the last century. However, during the 1990's so-called “2G” or second generation mobile phone systems were fielded that began the growth in both deployment and usage that we currently enjoy today. These initial systems predominately provided for the routing and reliable servicing of voice calls between parties. And, as one skilled in the art will appreciate, there are a number of timing and latency requirements associated with transmission and reception of voice data in order to maintain quality of service. As such, so-called circuit switched voice links have been fielded that guarantee this quality of service.

More recently, third generation (“3G”) technologies have been fielded that provide for more improved voice and data services. 3G cellular communications technologies generally fall into two camps: those employing Universal Mobile Telecommunications System (UMTS) and those employing CDMA2000 1xRTT (also referred to as “1x”). Both technologies provide for reliable transmission of voice, but neither UMTS nor 1x provide for reliable transmission of packetized data.

3G wireless technologies have matured to the point that communication devices are being incorporated into systems other than mobile telephones, and this application deals with one such system, namely automatic emergency automotive crash reporting systems.

Those skilled in the art will appreciate that many automobiles, trucks, buses, etc., include crash reporting systems that, upon detection of an accident, automatically turn on microphones and speakers within a vehicle to establish a voice connection with emergency services, such as the 911 emergency call system in the United States. These in-vehicle crash reporting systems may also transmit data associated with the crash and vehicle (e.g., airbag deployment, number of passengers, names of owners and special medical conditions) over a packetized data network to a different call center (e.g., OnStar), and the call center may provide this data to the emergency services.

In Europe, automatic crash reporting is more advanced and regulated that in the U.S. through the well known E112 system, where stringent requirements for auto manufacturers prescribe that in-band signaling be employed to transfer voice and vehicle crash data to an emergency call center within a four second period upon determination of a crash. Currently, in-vehicle crash reporting systems employing UMTS are fielded in Europe that meet these requirements through deployment of a dedicated modem for reporting crash data. The dedicated crash data reporting modem is provided to transfer the crash data over a UMTS voice circuit, and is provided in addition to a conventional UMTS voice modem which is employed to establish a voice call to emergency services. To satisfy the four second turnaround requirement, the dedicated modem is configured to communicate vehicle crash data to the emergency call center over a UMTS voice link, because quality of service cannot be guaranteed via a UMTS packetized data link. Thus, vehicle crash data is reported to the E112 call center via a unique protocol that is employed to transfer the data over a UMTS voice link, in many respects analogous to the protocol that is employed to transmit facsimile data over the public switched telephone network (PSTN).

The present inventor has observed that utilization of UMTS technologies is disadvantageous for automatic crash reporting because a dedicated modem must be deployed in in-vehicle crash reporting systems, and a unique protocol must also be employed to communicate crash data to the emergency call center, these special provisions resulting from the fact that cellular packetized data networks currently do not provide the quality of service to meet stringent crash reporting requirements. The present inventor has also observed that other packetized data crash reporting systems such as OnStar are lacking in that there is no guarantee that crash data will reliably be received by an emergency call center.

Accordingly, what is needed is an in-vehicle crash reporting mechanism that does not require a dedicated vehicle crash data reporting modem to reliably transmit vehicle crash data to an emergency call center.

What is also needed is an in-vehicle crash reporting device that utilizes a single, conventionally available modem that, in the event of a crash, automatically establishes a voice link with and reliably transmits crash data to an emergency call center.

### SUMMARY OF THE INVENTION

The present invention, among other applications, is directed to solving the above-noted problems and addresses other problems, disadvantages, and limitations of the prior art.

The present invention provides a superior technique for automatically transmitting vehicle crash data to emergency services in a timely manner. In one embodiment, an emergency call apparatus is provided that includes an applications processor and a code division multiple access (CDMA) modem. The applications processor is configured to receive current location data and vehicle crash data from sensors disposed in an automotive vehicle, and is configured to automatically establish a voice connection with an emergency services center, and is configured to transmit the location and vehicle crash data to the emergency services center within a prescribed time period. The CDMA modem is coupled to the applications processor and is configured to format and transmit a plurality of protocol data units (PDUs) over a single traffic channel that includes both primary traffic corresponding to the voice connection and other traffic corresponding to the location and vehicle crash data.

One aspect of the present invention contemplates an emergency call apparatus that includes an applications processor, a code division multiple access (CDMA) modem, and CDMA network elements. The applications processor is configured to receive current location data and vehicle crash data from sensors disposed in an automotive vehicle, and is configured to automatically establish a voice connection with an emergency services center, and is configured to transmit the location and vehicle crash data to the emergency services center within a prescribed time period. The CDMA modem is coupled to the applications processor and is configured to format and transmit a plurality of protocol data units (PDUs) over a single traffic channel that includes both primary traffic corresponding to the voice connection and other traffic corresponding to the location and vehicle crash data. The CDMA network elements are coupled to the CDMA modem, and are configured to route the primary traffic to the emergency services center via a public switched telephone network and the other traffic to a message processor, for delivery to the emergency services center.

Another aspect of the present invention comprehends a method for vehicle crash data reporting. The method includes: via a application processor disposed in an automotive vehicle, receiving current location data and vehicle crash data from sensors disposed in the automotive vehicle, and automatically establishing a voice connection with an emergency services center, and transmitting the location and vehicle crash data to the emergency services center within a prescribed time period; and via a modem disposed in the vehicle, formatting and transmitting a plurality of protocol data units (PDUs) over a single traffic channel that includes both primary traffic corresponding to the voice connection and other traffic corresponding to the location and vehicle crash data.

### BRIEF DESCRIPTION OF THE DRAWINGS

These and other objects, features, and advantages of the present invention will become better understood with regard to the following description, and accompanying drawings where:

FIG. 1 is a diagram illustrating a CDMA-based emergency call system according to the present invention;

FIG. 2 is a block diagram depicting the emergency call system of FIG. 1;

FIG. 3 is a block diagram featuring one embodiment of the present invention where minimum set of data (MSD) is embedded in secondary traffic of a 1x protocol data unit (PDU);

FIG. 4 is a block diagram showing another embodiment of the present invention where minimum set of data (MSD) is provided via short message service (SMS) within a 1x PDU; and

FIG. 5 is a block diagram illustrating a further embodiment of the present invention where minimum set of data (MSD) is provided in a burst message within a 1x PDU.

### DETAILED DESCRIPTION

Exemplary and illustrative embodiments of the invention are described below. In the interest of clarity, not all features of an actual implementation are described in this specification, for those skilled in the art will appreciate that in the development of any such actual embodiment, numerous implementation specific decisions are made to achieve specific goals, such as compliance with system-related and business related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

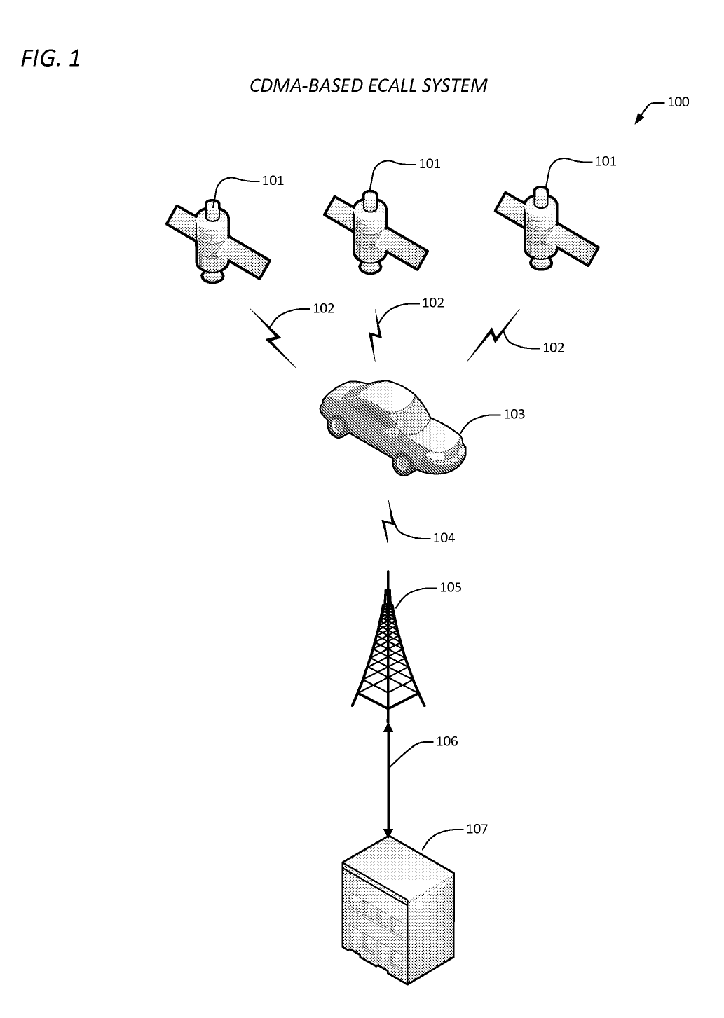

In view of the above background discussion on present day in-vehicle crash reporting systems and their attendant disadvantages and limitations, a discussion of the present invention will be presented with reference to FIGS. 1-5. The present invention overcomes the limitations of present day in-vehicle crash reporting systems by providing apparatus and methods for an emergency call system that employs a single, conventional modem to automatically and reliably establish an emergency voice call and transmit vehicle crash data to an emergency call center over a code division multiple access (CDMA) cellular network, such as a CDMA2000 1xRTT network, hereinafter referred to as a 1x network.

Referring to FIG. 1, a diagram is presented illustrating a CDMA-based emergency call (ecall) system according to the present invention. The ecall system may be disposed within an in-vehicle crash reporting system. The in-vehicle crash reporting system may be disposed in an automotive vehicle 103 that is employed for transportation purposes such as, but not limited to, an automobile, motorcycle, truck, or bus. The vehicle 103 may be coupled to one or more transponders 101 such as, but not limited to, global positioning system (GPS) satellites, via one or more satellite communications links 102, where information derived from the transponders 101 is employed by the in-vehicle system to determine its accurate location. The vehicle 103 is also coupled to a CDMA-based cellular communications network 105 via a CDMA-based wireless radio link 104. In one embodiment, the network 105 and link 104 comport with well known 1x protocol standards. The CDMA-based cellular communications network 105 is coupled to a public safety answering point (PSAP) 107 via a conventional public switched telephone network (PSTN) 106. The PSAP 107 is the term employed under the European E112 standards to refer to a dispatch center for emergency services.

Operationally, the system within the vehicle 103 monitors information provided by the transponders 101 to regularly determine, according to well known techniques, an accurate location of the vehicle 103. The system within the vehicle 103 additionally maintains registration with the CDMA-based network 105 via link 104 and may, in the absence of transponder signals via link 102, utilize data derived from the CDMA-based network 105, to determine, according to well known techniques, approximate location of the vehicle 103.

The in-vehicle system may employ sensors within the vehicle 103 to detect conditions according to present day techniques that indicate a collision has occurred, such as air bag deployment, front end crumpling, indicative deceleration, seat belt over-tension, etc. Upon detection of a collision, the in-vehicle system may automatically employ a single voice channel connection via radio link 104 over the CDMA-based network 105 to establish a voice connection with the PSAP 107 and simultaneously transmit vehicle crash data (hereinafter referred to as “minimum set of data” (MSD) over the same channel 104 for reception by the PSAP within a pre-defined time period. In one embodiment, the channel 104 is a 1x channel that employs an existing 1x protocol data unit (PDU) for reliable transmission of both voice and data over the 1x link 104, ensuring delivery of the vehicle crash data within the pre-defined period. In one embodiment, the vehicle crash data and pre-defined period comport with selected ecall data and timing constraints extracted from 3GPP TS 22.101, Service Aspect Service Principles (Release 13) and TS 26.267, Technical Specification Group Services and Service Aspects; Ecall Data Transfer; In-band Modem Solution; General Description (Release 10) of the 3rd Generation Partnership Project as follows:
The data may be sent prior to, or in parallel with, or at the start of the voice component of an emergency call;
Both the voice and data components of the emergency call shall be routed to the same PSAP or designated emergency call centre;
The data message contains pertinent information about the vehicle and the passengers. These information are stored in semi-permanent memory of the modem;
The minimum set of data (MSD) sent by the in-vehicle System (IVS) to the network shall not exceed 140 bytes; and
The MSD shall be delivered to the interface to the PSAP within a maximum of 4 seconds from when the MSD is available.

Other data formats and timing requirements are contemplated.

Advantageously, a CDMA-based ecall solution, as will be described in further detail below, allows for use of a single, conventional CDMA-based modem to meet the data and timing constraints noted above, where both voice and data are transferred to the PSAP 107 over a single 1x traffic channel via radio link 104.

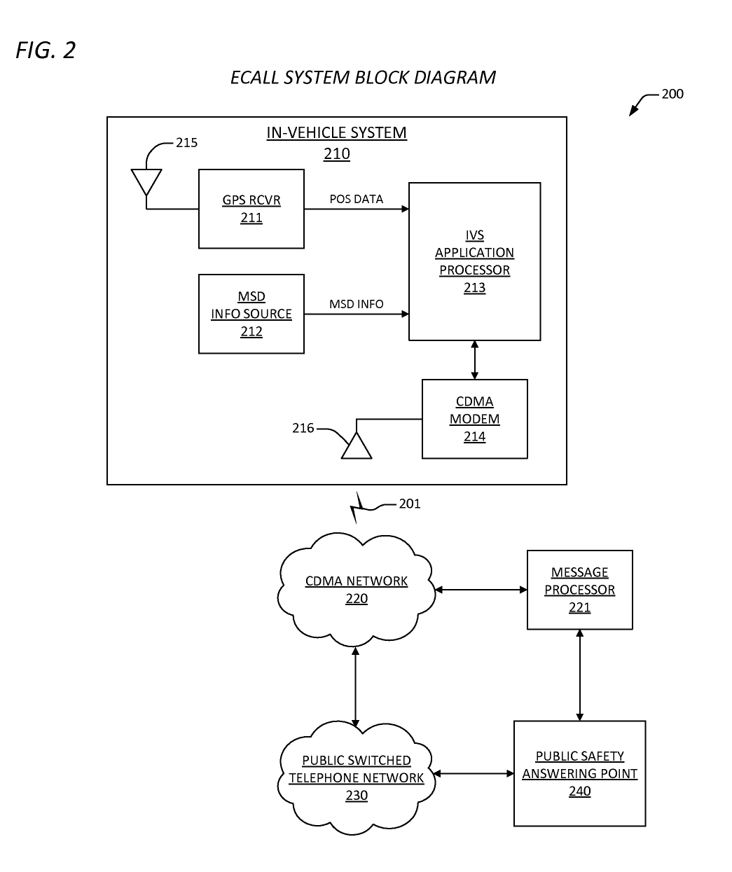

Turning now to FIG. 2, a block diagram is presented depicting the emergency call system 200 of FIG. 1. The ecall system 200 includes an in-vehicle system 210 disposed within an automotive transport device. The in-vehicle system 210 includes a GPS receiver 211 and an MSD information source 212, both of which are coupled to an in-vehicle system (IVS) application processor 213. The GPS receiver 211 is coupled to one or more antennas 215 that receive signals from GPS satellites. The processor 213 is coupled to a single CDMA modem 214, which is coupled to a 1x air interface transceive antenna 216.

The IVS 210 is coupled to CDMA2000 1xRTT network components 220 (e.g., base station, base station controller, and mobile switching center) via a 1x air interface link 201. The network components 220 are coupled to a public switched telephone network (PSTN) 230 via well known techniques. And the PSTN 230 couples the network components 220 to the PSAP 240 over one or more public landlines. The CDMA network components 220 are coupled to a message processor 221, which is coupled to the PSAP 240 or which is optionally disposed within the PSAP 240.

In operation, upon detection of a collision, location of the vehicle within which the IVS 210 is disposed is provided to the IVS processor 213 over bus POS DATA. Likewise, vehicle crash data is provided to the IVS processor 213 over bus MSD INFO. Within a pre-defined time period, the IVS processor 213 automatically establishes a connection with the PSAP 240 over the 1x link 201 and, embeds the vehicle crash data within a plurality of 1x PDUs that include voice data transmitted to the PSAP 240. According to the embodiments described below, the vehicle crash data may be transmitted as 1x secondary traffic or as signaling traffic. The network components 220 extract the voice traffic (i.e., primary traffic) from the 1xPDUs and route an emergency voice call to the PSAP over the PSTN 230. The network components 220 extract the secondary or signaling traffic from the 1x PDUs and route the secondary or signaling traffic to the message processor 221. The message processor 221 extracts the vehicle crash data from the secondary or signaling traffic, and provides the crash data to the PSAP 240 within the specified time period.

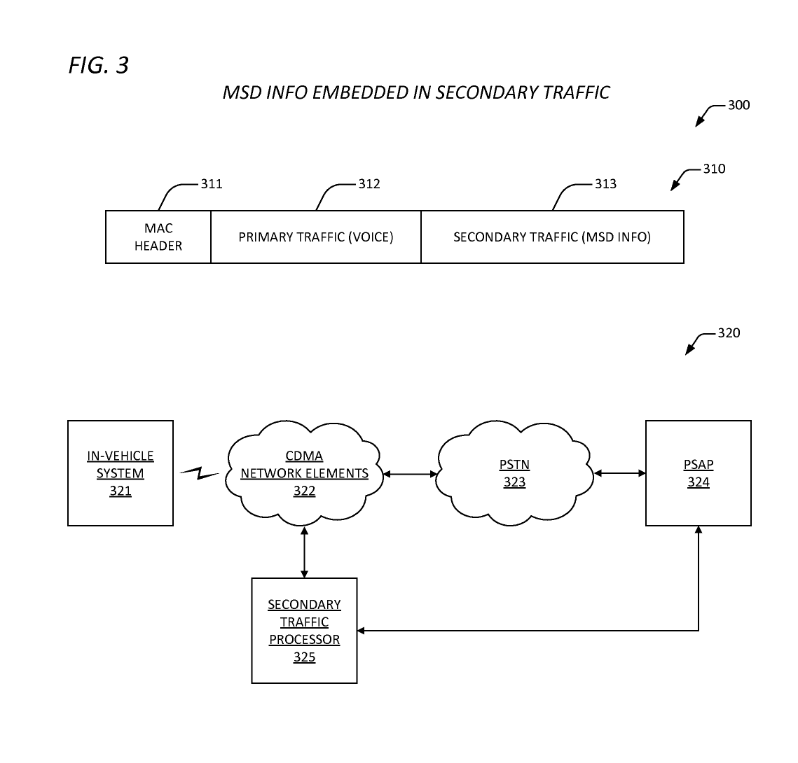

As one skilled in the art will appreciate, there are several different mechanisms within the 1x protocol set that provide for embedding of data into the same PDU (or, “frame”) as primary (i.e., voice) traffic. Embodiments of the present invention that allow for embedding vehicle crash data within 1x PDUs along with primary traffic will now be discussed with reference to FIGS. 3-5.

Turning now to FIG. 3, a block diagram 300 is presented featuring one embodiment of the present invention where minimum set of data (MSD) is embedded in secondary traffic of a 1x protocol data unit (PDU) 310. The diagram 300 depicts a 1x mux PDU type 1 310 as is described in 3GPP2 C.S0003-A, Medium Access Control (MAC) Standard for cdma2000 Spread Spectrum Systems Release A. As one skilled in the art will appreciate, a 1x frame 310 was originally intended to carry either two voice calls or both voice and data. Thus the PDU type 1 310 includes a MAC header field 311, a primary traffic field 312, and a secondary traffic field 313. According to C.S.0003-A, if the contents of the MAC header field 311 are configured to indicate mixed mode, the minimum number of bits provided for data in the secondary traffic field 313 is 88 bits/block, yielding 80 bits for primary traffic (i.e., voice) in the primary traffic field 312. Thus, to transmit 140 bytes according to the E112 requirements, transmission of MSD information would take 12 20-millisecond frames, that is, 0.24 seconds, which is well below the European mandatory 4-second turnaround time requirement.

The diagram 300 also depicts a data flow diagram 320 that includes an in-vehicle system (IVS) 321 coupled via a 1x link to CDMA network elements 322. The network elements 322 are coupled to a PSTN 323, which is coupled to the PSAP 324. The network elements 322 are also coupled to a secondary traffic processor 325, which is coupled to the PSAP 324. In one embodiment, the secondary traffic processor 325 is disposed within the PSAP 324.

Operationally, when the IVS 321 triggers and emergency call, a 1x modem (not shown) within the IVS 321 will negotiate with the 1x network elements 322 (i.e., a base station to which the modem is registered) for 1x voice service option 3 (SO3) for voice call data corresponding with the emergency call, and for a data service option to transmit the MSD over secondary traffic of the same channel. Accordingly, the network elements 322 route the primary traffic 312 through the PSTN 323 to the PSAP 324 to allow emergency personnel to communicate with occupants corresponding to the IVS 321. The network elements 322 route the MSD in secondary traffic 313 over the same channel to the traffic processor 325, which extracts the MSD and forwards vehicle crash data to the PSAP 324 in the timeline noted above.

The present inventor notes that the embodiment disclosed above with reference to FIG. 3 does not require any changes whatsoever to existing 1x RTT protocol standards.

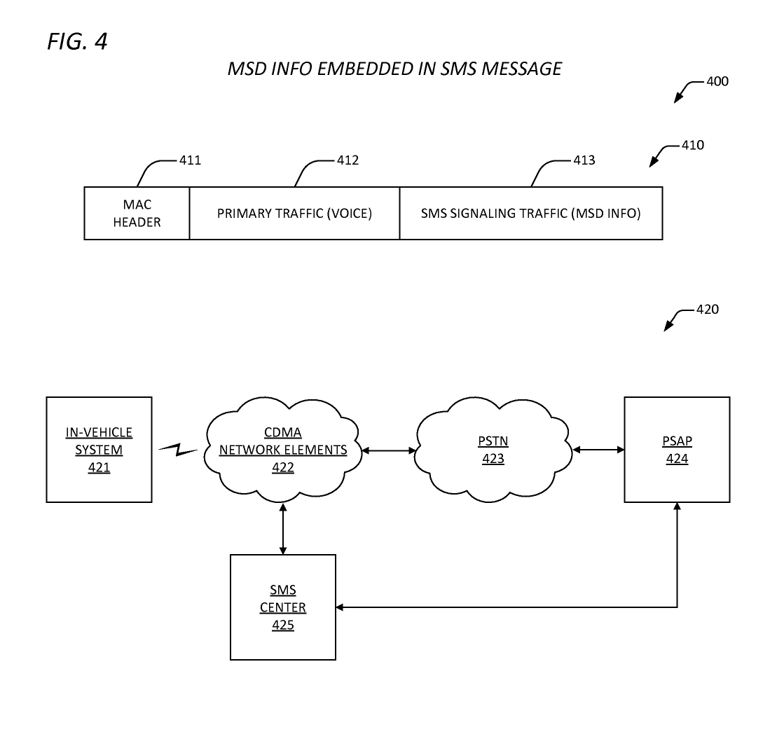

Now referring to FIG. 4, a block diagram 400 is presented showing another embodiment of the present invention where minimum set of data (MSD) is provided via short message service (SMS) within a 1x PDU. The diagram 400 depicts a 1x PDU 410. As one skilled in the art will appreciate, a 1x frame 410 may alternatively be employed to carry both voice and short message service (SMS) data in the same PDU 410. Thus the PDU 410 includes a MAC header field 411, a primary traffic field 412, and an SMS field 413. According to 3GPP2 C.S0015-B, Short Message Service (SMS) for Wideband Spread Spectrum Systems Release B, SMS message data is transmitted in signaling traffic 413 of the PDU 410, and the minimum number of bits provided for data in the signaling traffic field 413 is 88 bits/block, yielding 80 bits for primary traffic (i.e., voice) in the primary traffic field 412. Thus, to transmit 140 bytes according to the E112 requirements, transmission of MSD information would take 12 20-millisecond frames, that is, 0.24 seconds, which is well below the European mandatory 4-second turnaround time requirement.

The diagram 400 also depicts a data flow diagram 420 that includes an in-vehicle system (IVS) 421 coupled via a 1x link to CDMA network elements 422. The network elements 422 are coupled to a PSTN 423, which is coupled to the PSAP 424. The network elements 422 are also coupled to an SMS center 425, which is coupled to the PSAP 422. In one embodiment, the SMS center 425 is disposed within the PSAP 424.

Operationally, when the IVS 421 triggers and emergency call, a 1x modem (not shown) within the IVS 421 will negotiate with the 1x network elements 422 for 1x voice service option 3 (SO3) for voice call data corresponding with the emergency call, and for an SMS service option to transmit the MSD over signaling traffic of the same 1x channel. Accordingly, the network elements 422 route the primary traffic 412 through the PSTN 423 to the PSAP 424 to allow emergency personnel to communicate with occupants corresponding to the IVS 421. The network elements 422 route the MSD in signaling traffic 413 to the SMS processor 425, which extracts the MSD and forwards vehicle crash data to the PSAP 424 in the timeline noted above.

The present inventor notes that the embodiment disclosed above with reference to FIG. 4 requires that a new SMS teleservice (e.g., ecall SMS) be added to the C.S0015 specification to allow for ecall data to be transmitted via an SMS burst.

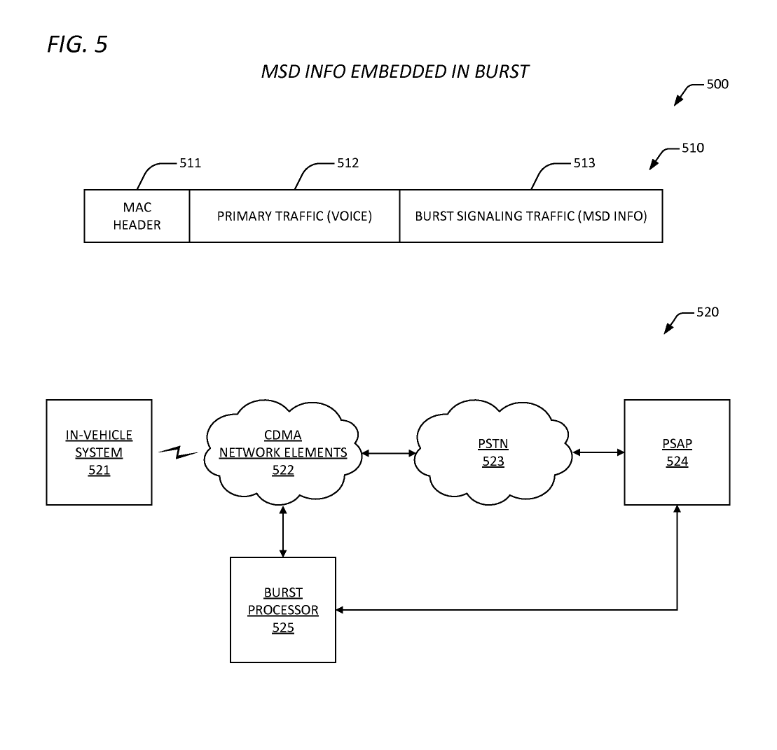

Finally turning to FIG. 5, a block diagram 500 is presented illustrating a further embodiment of the present invention where minimum set of data (MSD) is provided in a burst message within a 1x PDU. As one skilled in the art will appreciate, a 1x frame 510 may alternatively be employed carry voice and a burst message (SMS is one type of burst message) in the same PDU 510. Thus the PDU 510 includes a MAC header field 511, a primary traffic field 512, and a burst field 513. As one skilled in the art will appreciate, the above noted SMS standard describes one burst message type for 1x systems. Additional burst types are listed in 3GPP2 C.R1001 Administration of Parameter Value Assignments for cdma2000 Spread Spectrum Standards Release G, and are specified in 3GPP2 CS0016 Over-the-Air Service Provisioning of Mobile Stations in Spread Spectrum Standards (for over-the-air service provisioning (OTASP) burst data) and 3GPP2 C.S0105-A Unstructured Supplementary Service Data (USSD) Service Options for Spread Spectrum Systems: Service Options 78 and 79 (for unstructured supplemental service burst data). Like the SMS message of FIG. 4, burst message data is transmitted in signaling traffic 513 of the PDU 511, and it is contemplated that a new burst type be listed in the C.R1001 standard along with creation of a new standard for an MSD ecall burst message. The minimum number of bits provided for data in the signaling traffic field 513 is 88 bits/block, yielding 80 bits for primary traffic (i.e., voice) in the primary traffic field 512. Thus, to transmit 140 bytes according to the E112 requirements, MSD information transmission would take 12 20-millisecond frames, that is, 0.24 seconds, which is well below the European mandatory 4-second turnaround time requirement.

The diagram 500 also depicts a data flow 520 that includes an in-vehicle system (IVS) 521 coupled via a 1x link to CDMA network elements 522. The network elements 522 are coupled to a PSTN 523, which is coupled to the PSAP 524. The network elements 522 are also coupled to a burst message processor 525, which is coupled to the PSAP 522. In one embodiment, the burst message processor 525 is disposed within the PSAP 524.

Operationally, when the IVS 521 triggers and emergency call, a 1x modem (not shown) within the IVS 521 will negotiate with the 1x network elements 522 for 1x voice service option 3 (SO3) for voice call data corresponding with the emergency call, and a new burst message service option to transmit the MSD over signaling traffic. Accordingly, the network elements 522 route the primary traffic 512 through the PSTN 523 to the PSAP 524 to allow emergency personnel to communicate with occupants corresponding to the IVS 521. The network elements 522 route the MSD information in signaling traffic 513 to the burst message processor 525, which extracts the MSD information and forwards vehicle crash data to the PSAP 524 in the timeline noted above.

Advantageously, CDMA-based systems such as 1x do not suffer the bandwidth problems associated with UMTS systems, and can accommodate both primary traffic (voice) and data within single PDUs. Vocoder algorithms have greatly improved over the years such that vehicle crash data can be easily embedded in single frames along with primary traffic, thus allowing for use of a single CDMA modem in IVS systems.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, a microprocessor, a central processing unit, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be electronic (e.g., read only memory, flash read only memory, electrically programmable read only memory), random access memory magnetic (e.g., a floppy disk or a hard drive) or optical (e.g., a compact disk read only memory, or “CD ROM”), and may be read only or random access. Similarly, the transmission medium may be metal traces, twisted wire pairs, coaxial cable, optical fiber, or some other suitable transmission medium known to the art. The invention is not limited by these aspects of any given implementation.

The particular embodiments disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims.

What is claimed is:

1. An emergency call apparatus, comprising:
an applications processor, configured to receive current location data and vehicle crash data from sensors disposed in an automotive vehicle, and configured to automatically establish a voice connection with an emergency services center, and configured to transmit said location and vehicle crash data to said emergency services center within a prescribed time period; and
a code division multiple access (CDMA) modem, coupled to said applications processor, configured to format and transmit a plurality of protocol data units (PDUs) over a single traffic channel that includes both primary traffic corresponding to said voice connection and other traffic corresponding to said location and vehicle crash data.

2. The emergency call apparatus as recited in claim 1, wherein said one or more sensors comprise a global positioning system (GPS) receiver disposed within said automotive vehicle, for determination of said location data.

3. The emergency call apparatus as recited in claim 2, wherein said one or more sensors further comprise a minimum set of data (MSD) information source disposed within said automotive vehicle, for determination of said vehicle crash data.

4. The emergency call apparatus as recited in claim 3, wherein said single traffic channel comprises a 1x mux type 1 protocol data unit (PDU), and wherein said other traffic comprises secondary traffic within said PDU.

5. The emergency call apparatus as recited in claim 3, wherein said single traffic channel comprises a 1x mux type 1 protocol data unit (PDU), and wherein said other traffic comprises signaling traffic within said PDU, and wherein short message service (SMS) is employed to transmit said vehicle crash data.

6. The emergency call apparatus as recited in claim 3, wherein said single traffic channel comprises a 1x mux type 1 protocol data unit (PDU), and wherein said other traffic comprises signaling traffic within said PDU, and wherein a burst message service other than short message service is employed to transmit said vehicle crash data.

7. The emergency call apparatus as recited in claim 1, wherein said prescribed time period comprises a 4-second period.

8. An emergency call apparatus, comprising:
an applications processor, configured to receive current location data and vehicle crash data from sensors disposed in an automotive vehicle, and configured to automatically establish a voice connection with an emergency services center, and configured to transmit said location and vehicle crash data to said emergency services center within a prescribed time period;
a code division multiple access (CDMA) modem, coupled to said applications processor, configured to format and transmit a plurality of protocol data units (PDUs) over a single traffic channel that includes both primary traffic corresponding to said voice connection and other traffic corresponding to said location and vehicle crash data; and
CDMA network elements, coupled to said CDMA modem, configured to route said primary traffic to said emergency services center via a public switched telephone network and said other traffic to a message processor, for delivery to said emergency services center.

9. The emergency call apparatus as recited in claim 8, wherein said one or more sensors comprise a global positioning system (GPS) receiver disposed within said automotive vehicle, for determination of said location data.

10. The emergency call apparatus as recited in claim 9, wherein said one or more sensors further comprise a minimum set of data (MSD) information source disposed within said automotive vehicle, for determination of said vehicle crash data.

11. The emergency call apparatus as recited in claim 10, wherein said single traffic channel comprises a 1x mux type 1 protocol data unit (PDU), and wherein said other traffic comprises secondary traffic within said PDU.

12. The emergency call apparatus as recited in claim 10, wherein said single traffic channel comprises a 1x mux type 1 protocol data unit (PDU), and wherein said other traffic comprises signaling traffic within said PDU, and wherein short message service (SMS) is employed to transmit said vehicle crash data.

13. The emergency call apparatus as recited in claim 10, wherein said single traffic channel comprises a 1x mux type 1 protocol data unit (PDU), and wherein said other traffic comprises signaling traffic within said PDU, and wherein a burst message service other than short message service is employed to transmit said vehicle crash data.

14. The emergency call apparatus as recited in claim 8, wherein said prescribed time period comprises a 4-second period.

15. A method for vehicle crash data reporting, comprising:
via a application processor disposed in an automotive vehicle, receiving current location data and vehicle crash data from sensors disposed in the automotive vehicle, and automatically establishing a voice connection with an emergency services center, and transmitting the location and vehicle crash data to the emergency services center within a prescribed time period; and
via a modem disposed in the vehicle, formatting and transmitting a plurality of protocol data units (PDUs) over a single traffic channel that includes both primary traffic corresponding to the voice connection and other traffic corresponding to the location and vehicle crash data.

16. The method as recited in claim 15, wherein the one or more sensors comprise a global positioning system (GPS) receiver disposed within the automotive vehicle, for determination of the location data.

17. The method as recited in claim 16, wherein the one or more sensors further comprise a minimum set of data (MSD) information source disposed within the automotive vehicle, for determination of the vehicle crash data.

18. The method as recited in claim 17, wherein the single traffic channel comprises a 1x mux type 1 protocol data unit (PDU), and wherein the other traffic comprises secondary traffic within the PDU.

19. The method as recited in claim 17, wherein the single traffic channel comprises a 1x mux type 1 protocol data unit (PDU), and wherein the other traffic comprises signaling traffic within the PDU, and wherein short message service (SMS) is employed to transmit the vehicle crash data.

20. The method as recited in claim 17, wherein the single traffic channel comprises a 1x mux type 1 protocol data unit (PDU), and wherein the other traffic comprises signaling traffic within the PDU, and wherein a burst message service other than short message service is employed to transmit the vehicle crash data.

21. The method as recited in claim 15, wherein the prescribed time period comprises a 4-second period.
